(19) United States
(12) Patent Application Publication
(10) Pub. No.: US 2015/0308649 A1
(43) Pub. Date: Oct. 29, 2015

(54) LIGHT SOURCE MODULE AND ILLUMINATION DEVICE USING THE SAME

(71) Applicant: WALSIN LIHWA CORPORATION, Yangmei City (TW)

(72) Inventors: Chang-Ho Chen, Yangmei City (TW); Hsueh-Lung Chen, Yangmei City (TW); Tsung-Jen Teng, Yangmei City (TW); Yen-Ting Lin, Yangmei City (TW)

(73) Assignee: WALSIN LIHWA CORPORATION, Yangmei City (TW)

(21) Appl. No.: 14/664,328

(22) Filed: Mar. 20, 2015

Related U.S. Application Data
(60) Provisional application No. 61/969,441, filed on Mar. 24, 2014.

(30) Foreign Application Priority Data
Oct. 6, 2014 (TW) 103134682

(51) Int. Cl. F21S 8/10

(52) U.S. Cl. CPC F21S 48/1763; F21S 48/115; F21S 48/13; F21S 48/14; F21Y 2101/02

(57) ABSTRACT

An illumination device comprising a reflector and a light source module is provided. The light source module comprises a column, a first light-emitting diode (LED) light source, and a second LED light source. The column has a front end and a side. The first LED light source fixed to the front end of the column is configured to emit a first light beam for forming a first illumination area on a projection plane. The second LED light source fixed to the side of the column is configured to emit a second light beam for forming a second illumination area partly overlapping the first illumination area on the projection plane.

### CROSS-REFERENCES TO RELATED APPLICATIONS

This application claims the benefit of Provisional Application Ser. No. 61/969,441 filed on Mar. 24, 2014.

This application claims the benefit of priority based on Taiwan Patent Application No 103134682, filed on Oct. 6, 2014, the contents of which are incorporated herein by reference in their entirety.

### BACKGROUND OF THE INVENTION

1. Field of the Invention

The present invention is related to an illumination device and a light source module for the illumination device; and more particularly, the present invention is related to a vehicle illumination device and a light source module for the vehicle illumination device.

2. Descriptions of the Related Art

Headlights in motor vehicles are mainly used at night or in harsh environments for road lighting. In conventional vehicle headlights, halogen lamps or high intensity discharge (HID) lamps are commonly provided as the light source. In an HID lamp, light is generated by a discharge phenomenon that occurs between two metal electrodes respectively disposed at both ends of the HID lamp. Thus, compared to halogen lamps, HID lamps have higher lumen output, better luminous efficacy and longer lifetime. However, the lifetime of an HID lamp is generally only several hundred or several thousand hours. Therefore, seeking a new durable light source to replace conventional lamps for higher lumen output, better luminous efficacy and longer lifetime is a need for new motor vehicles.

With the development of integrated circuit (IC) design, semiconductor manufacturing and photovoltaic technology, light-emitting diode (LED) is a new type of solid-state light source in the 21st century. Compared to halogen lamps or HID lamps, LED lamps have smaller size, higher lumen output, better luminous efficacy, lower power consumption and longer lifetime. However, the optical, the thermal and the electrical designs of new LED lamps are different from those of halogen lamps or HID lamps. Automobile manufacturers have to reconsider different design rules for headlights with LED lamps during developing new motor vehicles. For example, the detailed designs of an LED headlight complying with vehicle lighting regulations are shown and described in U.S. Pat. No. 7,645,062 filed on Mar. 25, 2004 and entitled “Light Source and Vehicle Lamp.”

Moreover, as to existing motor vehicles having conventional headlights with halogen lamps or HID lamps, it is hard to directly utilize an LED lamp of a new headlight to replace a halogen lamp or an HID lamp of an original headlight due to different architectures between the original headlight and the new headlight. As a result, consumers will attenuate will of replacing the halogen lamp or the HID lamp with the LED lamp.

In view of this, it is important to provide an LED light source which can directly replace a light source of a halogen lamp or an HID lamp, such that the consumer can replace the light source of the halogen lamp or the HID lamp with the LED light source rapidly and precisely.

### SUMMARY OF THE INVENTION

An objective of the present invention is to provide light source module for an illumination device. The illumination device comprises a reflector.

To achieve the aforesaid objective, the light source module of the present invention comprises a column, a first LED light source and a second LED light source. The column has a front end and a side. The first LED light source is fixed to the front end of the column and emits a first light beam for forming a first illumination area. The second LED light source is fixed to the side of the column and emits a second light beam for forming a second illumination area via the reflector. The first illumination area partly overlaps the second illumination area.

Another objective of the present invention is to provide a light source module for an illumination device. The illumination device comprises a reflector and a shutter. The light source module comprises a column and an LED light source. The column faces the shutter along a direction and has at least one side. The LED light source is fixed to the at least one side of the column and emits a light beam for forming an illumination area via the reflector and through the shutter. The illumination area has a cut-off line. The at least one side of the column forms an angle with the direction. The angle is substantially less than 45 degrees.

Yet a further objective of the present invention is to provide a light source module for an illumination device. The illumination device comprises a reflector and a shutter. The light source module comprises a column and at least one LED light source. The column has at least one side. The at least one LED light source is fixed to the at least one side of the column and emits a light beam for forming an illumination area via the reflector and through the shutter. The illumination area has a cut-off line. The at least one LED light source has a plurality of LED chips. Each of distances between each two adjacent LED chips is substantially from 50 micrometer (μm) to 900 μm.

Another further objective of the present invention is to provide a vehicle illumination device which comprises a housing and a light source module. The light source module which is coupled to the housing comprises a column and an LED light source. The column has a front. The LED light source is fixed to the front end of the column and emits a light beam for forming an illumination area through the shutter. The illumination area has a cut-off line. The LED light source has an effective horizontal width which is substantially from 6 millimeter (mm) to 18 mm.

According to the above description, the illumination device and the light source module for the illumination device according to the present invention provide a light source complying with vehicle lighting regulations and architectures of original headlights in motor vehicles. Accordingly, the illumination device and the light source module for the illumination device according to the present invention can effectively overcome the problem of the prior art that, consumers will attenuate will of replacing the halogen lamp or the HID lamp with the LED lamp.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of one embodiment of a vehicle illumination device;

FIG. 2 is a schematic view of one embodiment of a light source module;

FIG. 3 is a schematic view of an illumination area formed on a projection plane by one embodiment of a vehicle illumination device shown in FIG. 1;

FIG. 4 is a schematic view of one embodiment of an LED light source of a light source module;

FIG. 5 is a sectional view of one embodiment of an LED light source of a light source module;

FIG. 6 is a schematic view of one embodiment of a vehicle illumination device;

FIG. 7 is a schematic view of one embodiment of a vehicle illumination device;

FIG. 8 is a schematic view of one embodiment of a light source module;

FIG. 9 is a schematic view of an illumination area formed on a projection plane by one embodiment of a vehicle illumination device shown in FIG. 7;

FIG. 10 is a schematic view of one embodiment of a vehicle illumination device;

FIG. 11 is a schematic view of one embodiment of a light source module;

FIG. 12 is a schematic view of one embodiment of a light source module; and

FIG. 13 is a schematic view of an illumination area formed on a projection plane by one embodiment of a vehicle illumination device shown in FIG. 10.

### DESCRIPTION OF THE PREFERRED EMBODIMENT

In the following description, this invention will be explained with reference to embodiments thereof. However, the description of these embodiments is only for purposes of illustration rather than limitation. It should be appreciated that in the following embodiments and attached drawings, elements unrelated to this invention are omitted from depictions; and dimensional relationships among individual elements in the attached drawings are illustrated only for ease of understanding, but not to limit the actual scale.

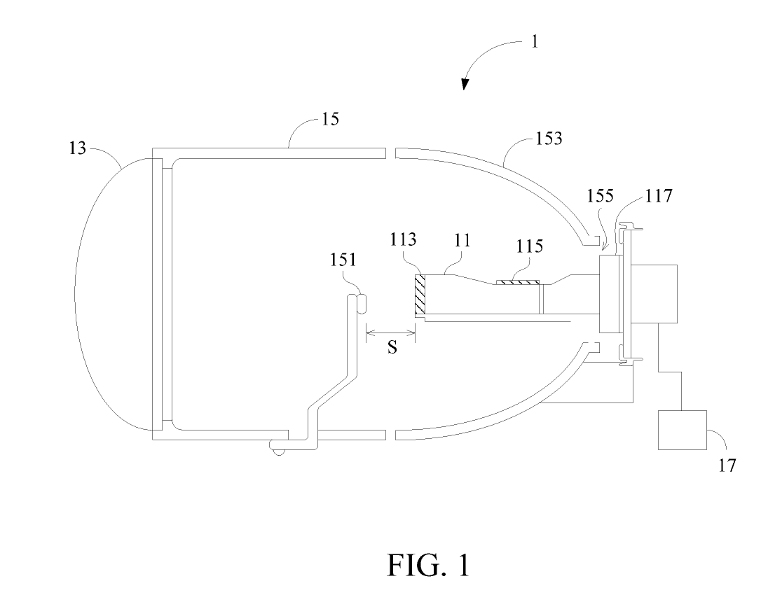

FIG. 1 depicts a vehicle illumination device 1. The vehicle illumination device 1 has a light source module 11, a convex lens 13, a housing 15, and a control circuit module 17. The housing 15 has a shutter 151, a reflector 153, and an opening 155. The light source module 11 has a first LED light source 113, a second LED light source 115, and a fixing part 117. The convex lens 13 has an optical axis (not shown) and a focus (not shown). The light source module 11 is fixed in the housing 15 by the fixing part 117 through the opening 155. The control circuit module 17 which is electrically connected to the light source module 11 controls a switch of the light source module 11. In one embodiment, the opening 155 has a diameter substantially greater than 18 mm for complying with architectures of original vehicle headlights having halogen lamps or HID lamps.

More specifically, the first LED light source 113 emits a first light beam (not shown) according to a control of the control circuit module 17. Similarly, the second LED light source 115 emits a second light beam (not shown) according to the control of the control circuit module 17. In one embodiment, the reflector 153 is a globular reflector for reflecting the second light beam. The first light beam and the reflected second light beam are partly shielded by the shutter 151 to form an illumination area complying with asymmetrical beam illumination regulations (i.e. ECE R112) on a projection plane with a distance of 25 meters ahead of the vehicle illumination device 1.

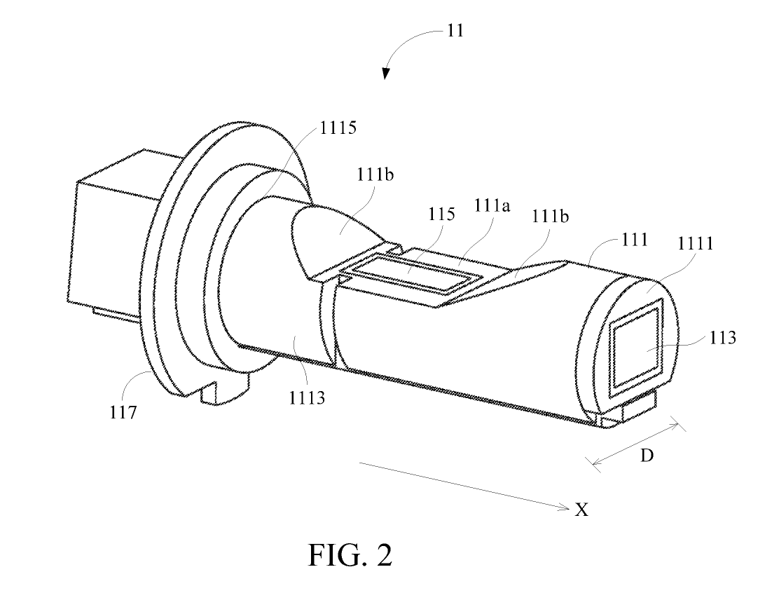

FIG. 2 depicts the light source module 11 for the vehicle illumination device 1. In addition to the first LED light source 113, the second LED light source 115, and the fixing part 117, the light source module 11 has a column 111. The column 111 has a front end 1111, a side 1113, and a back end 1115 opposite to the front end 1111. The side 1113 has a groove having a bottom 111a and two sidewalls 111b. The fixing part 117 is disposed near the back end 1115 of the column 111. In one embodiment, the column 111 is a cylinder having a side 1113. However, in other embodiments, the column 111 can be a column, such as, a cuboid, having a plurality of sides. It should be noted that the column 111 is not limited to be a cylinder having a side 1113 in the embodiment.

In one embodiment, the column 111 has a diameter D substantially from 6 mm to 18 mm. The light source module 11 is fixed in the housing 15 by the fixing part 117 through the opening 155 having the diameter substantially greater than 18 mm for complying with the architectures of original vehicle headlights having the halogen lamps or the HID lamps. Accordingly, the halogen lamps (e.g. H4, H7, H13, 9005, 9006, 9007) or the HID lamps (e.g. D1S, D2S, D4S) can be replaced by the light source module 11. Furthermore, there is a great amount of heat which decreases light efficiency of the light source module 11 when the first LED light source 113 and the second LED light source 115 respectively emit the first light beam and the second light beam. In one embodiment, the column 111 is made of heat conductive material for increasing cooling efficiency of the light source module 11. For example, the column 111 can be made of aluminum, copper, lead, tin, magnesium, zinc, steel, titanium, polymer, ceramic, or a combination of the aforesaid materials. In other embodiments, the column 111 can have at least one heat pipe (not shown), a plurality of fins (not shown), or heat conductive coating (not shown) for increasing the cooling efficiency of the light source module 11. The heat conductive coating is made of tin oxide, aluminum oxide, silicon carbide, boron oxide, graphene, or carbon nanotubes.

As shown in FIG. 1 and FIG. 2, the first LED light source 113 is fixed to the front end 1111 of the column 111. There is a distance S substantially from 1 mm to 8 mm between the first LED light source 113 and the shutter 151. The second LED light source 115 is fixed to the bottom 111a of the groove. In other words, the second LED light source 115 is fixed to the side 1113 of the column 111. The first light beam emitted by the first LED light source 113 has an optical path X. The optical path X forms an angle substantially from 20 degrees to 50 degrees with the sidewall 111b of the groove. In one embodiment, the optical path X of the first light beam and the optical axis of the convex lens 13 are arranged in a straight line. The shutter 151 is disposed on the optical path X of the first light beam and the focus of the convex lens 13. However, in other embodiments, the shutter 151 can be disposed on other locations. It should be noted that the shutter 151 is not limited to be disposed on the optical path X of the first light beam and the focus of the convex lens 13 in the embodiment.

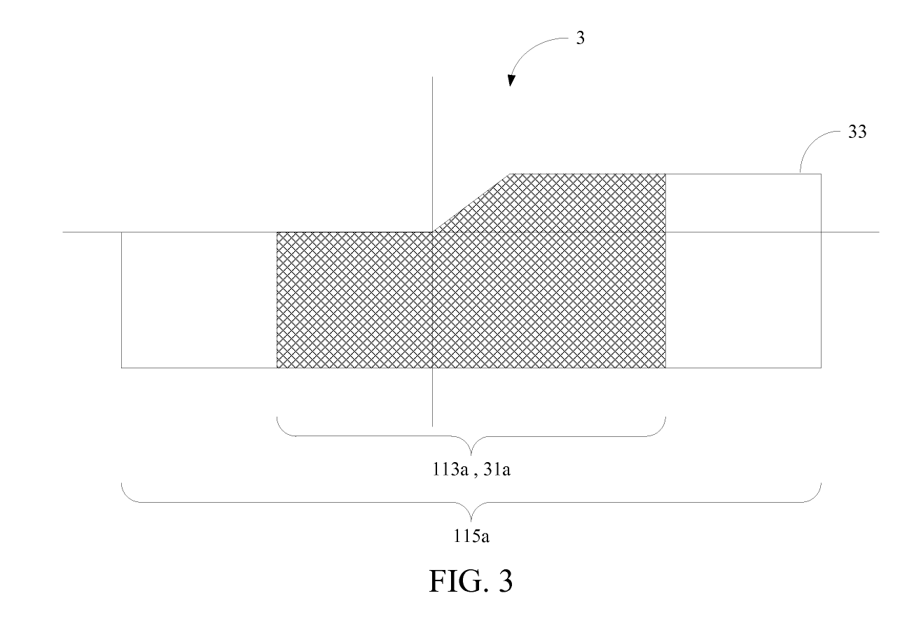

As shown in FIG. 3, an illumination area 3 is formed on the projection plane with the distance of 25 meters ahead of the vehicle illumination device 1 by the first light beam of the first LED light source 113 and the second light beam of the second LED light source 115. The first light beam is partly shielded by the shutter 151 to form a first illumination area 113a on the projection plane with the distance of 25 meters ahead of the vehicle illumination device 1. Similarly, the second light beam is partly shielded by the shutter 151 to form a second illumination area 115a on the projection plane with the distance of 25 meters ahead of the vehicle illumination device 1 after reflected by the reflector 153. Simultaneously, the first illumination area 113a partly overlaps the second illumination area 115a to form an overlap illumination area 31a.

More specifically, the first light beam directly forms the first illumination area 113a on the projection plane with the distance of 25 meters ahead of the vehicle illumination device 1 through the shutter 151. The second light beam forms the second illumination area 115a the projection plane with the distance of 25 meters ahead of the vehicle illumination device 1 through the shutter 151 after reflected by the reflector 153. Thus, luminance of the second illumination area 115a is less than luminance of the first illumination area 113a. An area of the first illumination area 113a is less than an area of the second illumination area 115a. Simultaneously, the first illumination area 113a and the second illumination area 115a have a cut-off line 33 for complying with asymmetrical beam illumination regulations (i.e. ECE R112).

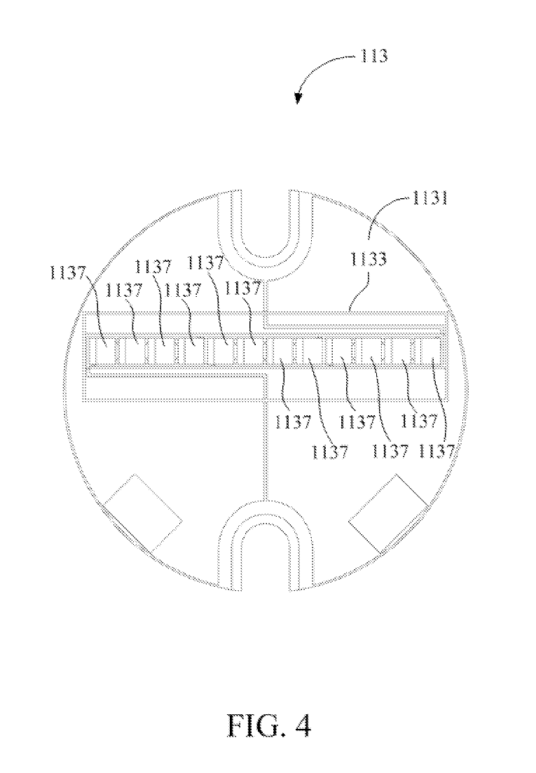

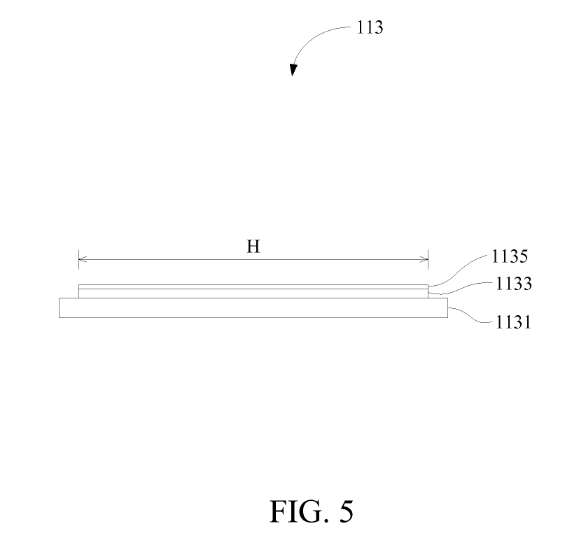

FIG. 4 and FIG. 5 respectively depict the schematic view and the sectional view of the first LED light source 113 of one embodiment. The first LED light source 113 has a substrate 1131, a protruding structure 1133, a fluorescent layer 1135, and a plurality of LED chips 1137. In one embodiment, the first LED light source 113 is made by chip-on-board (COB) package process. The detailed technical information of the LED package process can be referred to U.S. Pat. No. 7,732,233, filed on Jun. 10, 2009 and entitled “Method for making light emitting diode chip package,” and U.S. Pat. No. 8,129,206, filed on Jun. 9, 2009 and entitled “Light emitting diode package and method of making the same,” which are herein incorporated by reference.

More specifically, the LED chips 1137 are disposed on the substrate 1131 to form an LED array. Each of the LED chips 1137 emits a light beam. Each of distances between each two adjacent LED chips 1137 is substantially from 50 μm to 900 μm. The protruding structure 1133 which surrounds the LED chips 1137 is used for supporting the fluorescent layer 1135. The protruding structure 1133 has a height substantially from 0.5 mm to 1.5 mm. Accordingly, the fluorescent layer 1135 disposed on the LED chips 1137 has an effective horizontal width H substantially from 6 mm to 18 mm. The light beams emitted by the LED chips 1137 are mixed through the fluorescent layer 1135 to form the first light beam emitted by the first LED light source 113.

According to the above description, the first LED light source 113 has the effective horizontal width H substantially from 6 mm to 18 mm Each of the LED chips 1137 can be a horizontal-type LED chip, a vertical LED chip, or a flip LED chip. In one embodiment, the substrate 1131 is made of heat conductive material for increasing cooling efficiency of the first LED light source 113. For example, the substrate 1131 can be made of aluminum, copper, lead, tin, magnesium, zinc, steel, titanium, polymer, ceramic, or a combination of the aforesaid materials. The LED array of the first LED light source 113 has twelve LED chips 1137. Each of the distances between each two adjacent LED chips 1137 is substantially from 50 μm to 150 μm. However, in other embodiments, the LED array of the first LED light source 113 can have different number of LED chips 1137. It should be noted that the LED array of the first LED light source 113 is not limited to have twelve LED chips 1137 in the embodiment.

The LED array can be disposed on the substrate 1131 in a specific pattern, for example, but not limited to, an L shape, an U shape, an H shape, an M shape, an N shape, or a ⊥ shape according to different arrangements of the LED chips 1137. The detailed designs of the LED arrays can be referred to U.S. Design patent application No. 29/471,507, filed on Nov. 1, 2013 and entitled “Light Emitting Diode Device,” China Design patent application No. 201330532498.2, filed on Nov. 7, 2013 and entitled “Light Emitting Diode Device,” and Taiwan Design patent application No. 103301434, filed on Mar. 14, 2014 and entitled “Portion of Light Emitting Diode Device,” which are herein incorporated by reference.

The second LED light source 115 being approximately the same as the first LED light source 113 has a plurality of LED chips (not shown) to form an LED array. The LED array of the second LED light source 115 is a matrix LED array. More specifically, the LED array of the second LED light source 115 can be a 2×2 matrix LED array, a 3×3 matrix LED array, or a 4×4 matrix LED array according to different arrangements of the LED chips. For example, the second LED light source 115 has four LED chips when the LED array of the second LED light source 115 is the 2×2 matrix LED array. The second LED light source 115 has nine LED chips when the LED array of the second LED light source 115 is the 3×3 matrix LED array. The second LED light source 115 has sixteen LED chips when the LED array of the second LED light source 115 is the 4×4 matrix LED array.

In one embodiment, the second LED light source 115 is also a single COB chip with a diameter which is not greater than 6 mm, or between 4 mm and 6 mm. This single COB chip, for example, containing twelve 4545 LED flip chips, can generate more than 1500 lumens of 20 watts (6.5 volts and 3 amps) within a circular area to provide sufficient light for light distribution. That is, the light intensity (light flux per effective lighting area) of this single COB chip is no less than 100 Lm/mm².

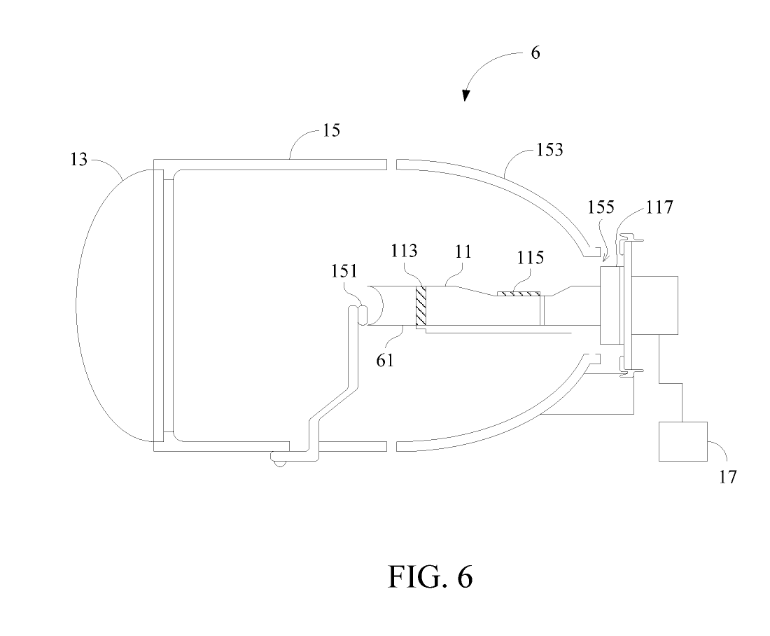

FIG. 6 depicts the schematic view of a vehicle illumination device 6 of one embodiment. The vehicle illumination device 6 being approximately the same as the vehicle illumination device 1 has a light source module 11, a convex lens 13, a housing 15, and a control circuit module 17. The housing 15 has a shutter 151, a reflector 153, and an opening 155. The light source module 11 has a first LED light source 113, a second LED light source 115, and a fixing part 117. The vehicle illumination device 6 further has a concave lens 61 fixed to the front end of the column. The concave lens 61 substantially adjoins with the shutter 151 to increase luminance of a first light beam emitted by the first LED light source 113.

In addition to the aforesaid description, the embodiment of the vehicle illumination device 6 can also execute all the operations and functions set forth in the embodiment of the vehicle illumination device 1. How the vehicle illumination device 6 executes these operations and functions will be readily appreciated by those of ordinary skill in the art based on the explanation of the vehicle illumination device 1 and, thus, will not be further described herein.

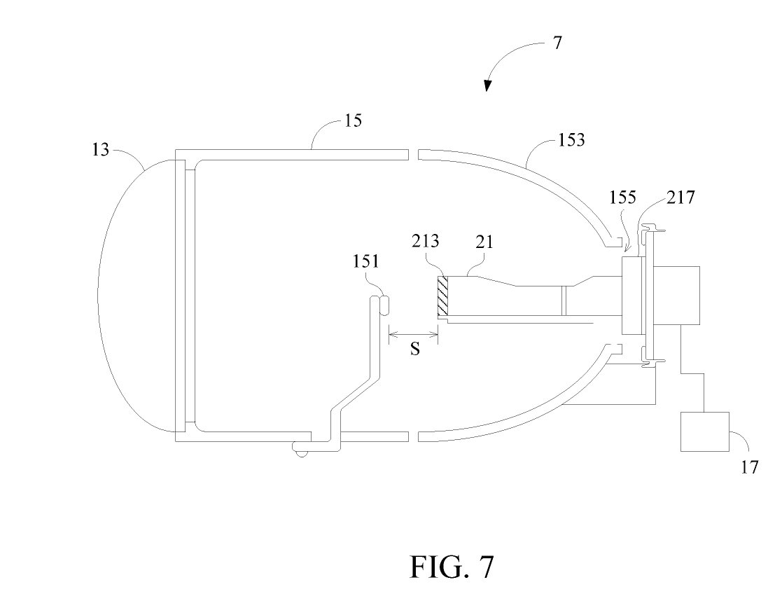

FIG. 7 depicts the schematic view of a vehicle illumination device 7 of one embodiment. The vehicle illumination device 7 being approximately the same as the vehicle illumination device 1 has a convex lens 13, a housing 15, and a control circuit module 17. The housing 15 has a shutter 151, a reflector 153, and an opening 155. The vehicle illumination device 7 further has a light source module 21 different from the light source module 11 of the vehicle illumination device 1. The light source module 21 has an LED light source 213 and a fixing part 217. The light source module 21 is fixed in the housing 15 by the fixing part 217 through the opening 155. The control circuit module 17 which is electrically connected to the light source module 21 controls a switch of the light source module 21.

More specifically, the LED light source 213 emits a light beam (not shown) according to a control of the control circuit module 17. The light beam is partly shielded by the shutter 151 to form an illumination area complying with asymmetrical beam illumination regulations (i.e. ECE R112) on a projection plane with a distance of 25 meters ahead of the vehicle illumination device 7.

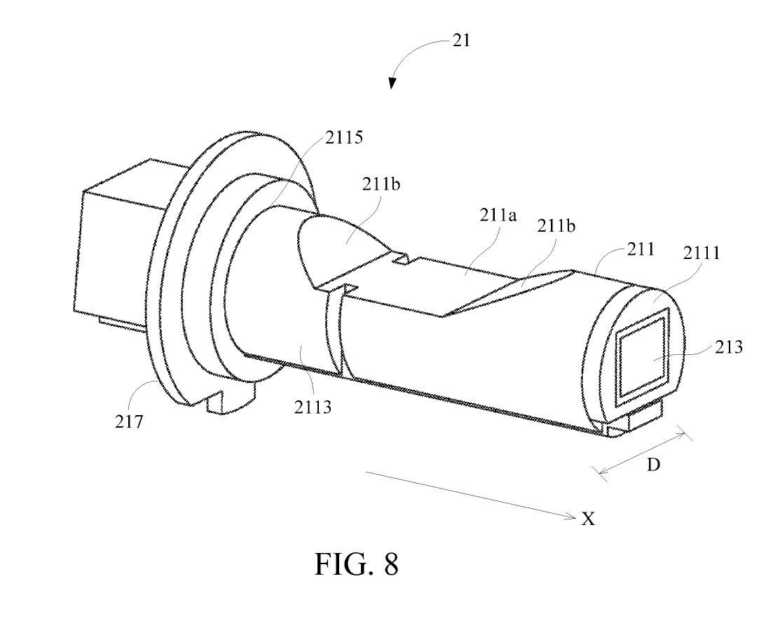

FIG. 8 depicts the light source module 21 for the vehicle illumination device 7. The light source module 21 is approximately the same as the light source module 11 of the vehicle illumination device 1. In addition to the LED light source 213 and the fixing part 217, the light source module 21 has a column 211. The column 211 has a front end 2111, a side 2113, and a back end 2115 opposite to the front end 2111. The side 2113 has a groove having a bottom 211a and two sidewalls 211b. The fixing part 217 is disposed near the back end 2115 of the column 211. In one embodiment, the column 211 is a cylinder having a side 2113. However, in other embodiments, the column 211 can be a column, such as, a cuboid, having a plurality of sides. It should be noted that the column 211 is not limited to be a cylinder having a side 2113 in the embodiment.

In one embodiment, the column 211 has a diameter D substantially from 6 mm to 18 mm. The light source module 21 is fixed in the housing 15 by the fixing part 217 through the opening 155 having the diameter substantially greater than 18 mm for complying with the architectures of original vehicle headlights having the halogen lamps or the HID lamps. Accordingly, the halogen lamps (e.g. H4, H7, H13, 9005, 9006, 9007) or the HID lamps (e.g. D1S, D2S, D4S) can be replaced by the light source module 21. Furthermore, there is a great amount of heat which decreases light efficiency of the light source module 21 when the LED light source 213 emits the light beam. In one embodiment, the column 211 is made of heat conductive material for increasing cooling efficiency of the light source module 21. For example, the column 211 can be made of aluminum, copper, lead, tin, magnesium, zinc, steel, titanium, polymer, ceramic, or a combination of the aforesaid materials. In other embodiments, the column 211 can have at least one heat pipe (not shown), a plurality of fins (not shown), or heat conductive coating (not shown) for increasing the cooling efficiency of the light source module 21. The heat conductive coating is made of tin oxide, aluminum oxide, silicon carbide, boron oxide, graphene, or carbon nanotubes.

As shown in FIG. 7 and FIG. 8, the LED light source 213 is fixed to the front end 2111 of the column 211. There is a distance S substantially from 1 mm to 8 mm between the LED light source 213 and the shutter 151. The light beam emitted by the LED light source 213 has an optical path X. In one embodiment, the optical path X of the light beam and the optical axis of the convex lens 13 are arranged in a straight line. The shutter 151 is disposed on the optical path X of the light beam and a focus of the convex lens 13. However, in other embodiments, the shutter 151 can be disposed on other locations. It should be noted that the shutter 151 is not limited to be disposed on the optical path X of the light beam and the focus of the convex lens 13 in the embodiment.

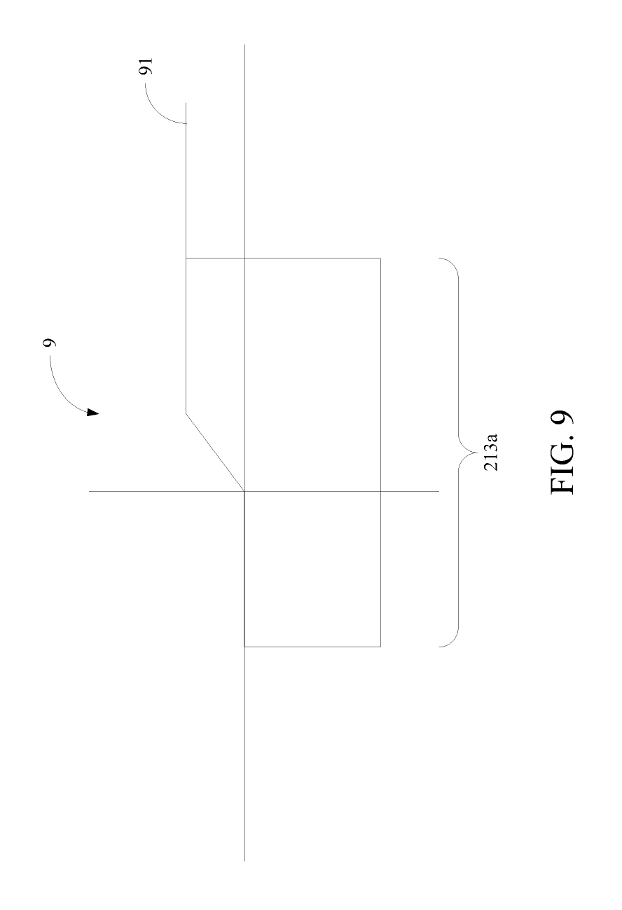

As shown in FIG. 9, an illumination area 9 is formed on the projection plane with the distance of 25 meters ahead of the vehicle illumination device 7 by the light beam of the LED light source 213. The light beam emitted by the LED light source 213 is partly shielded by the shutter 151 to form an illumination area 213a on the projection plane with the distance of 25 meters ahead of the vehicle illumination device 7. Thus, the illumination area 213a has a cut-off line 91 for complying with asymmetrical beam illumination regulations (i.e. ECE R112).

The architectures of the LED light source 213 will be readily appreciated by those of ordinary skill in the art based on the explanation of the first LED light source 113 of the light source module 11 and, thus, will not be further described herein.

In addition to the aforesaid description, the embodiment of the vehicle illumination device 7 can also execute all the operations and functions set forth in the embodiment of the vehicle illumination device 1. How the vehicle illumination device 7 executes these operations and functions will be readily appreciated by those of ordinary skill in the art based on the explanation of the vehicle illumination device 1 and, thus, will not be further described herein.

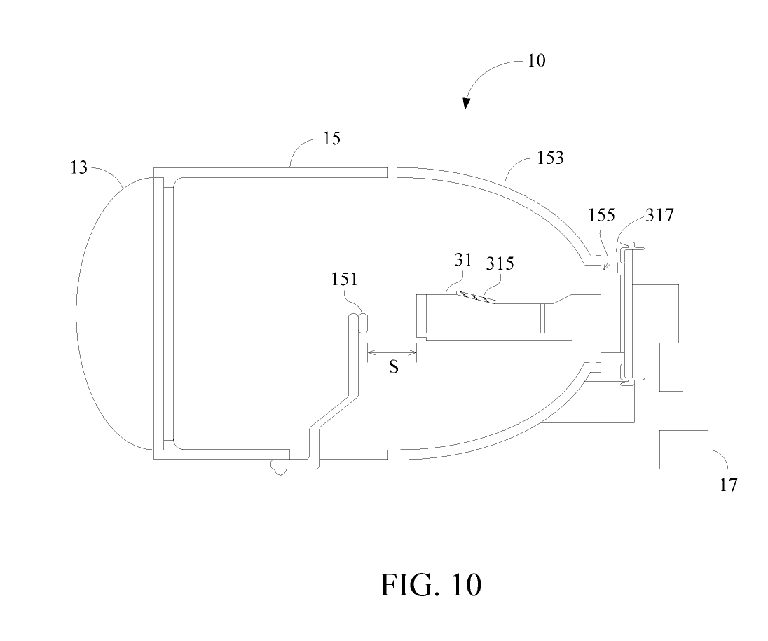

FIG. 10 depicts the schematic view of a vehicle illumination device 10 of one embodiment. The vehicle illumination device 10 being approximately the same as the vehicle illumination device 1 has a convex lens 13, a housing 15, and a control circuit module 17. The housing 15 has a shutter 151, a reflector 153, and an opening 155. The vehicle illumination device 10 further has a light source module 31 different from the light source module 11 of the vehicle illumination device 1. The light source module 31 has an LED light source 315 and a fixing part 317. The light source module 31 is fixed in the housing 15 by the fixing part 317 through the opening 155. The control circuit module 17 which is electrically connected to the light source module 31 controls a switch of the light source module 31.

More specifically, the second light source 315 emits a light beam (not shown) according to the control of the control circuit module 17. In one embodiment, the reflector 153 is a globular reflector for reflecting the light beam. The reflected light beam is partly shielded by the shutter 151 to form an illumination area complying with asymmetrical beam illumination regulations (i.e. ECE R112) on a projection plane with a distance of 25 meters ahead of the vehicle illumination device 10.

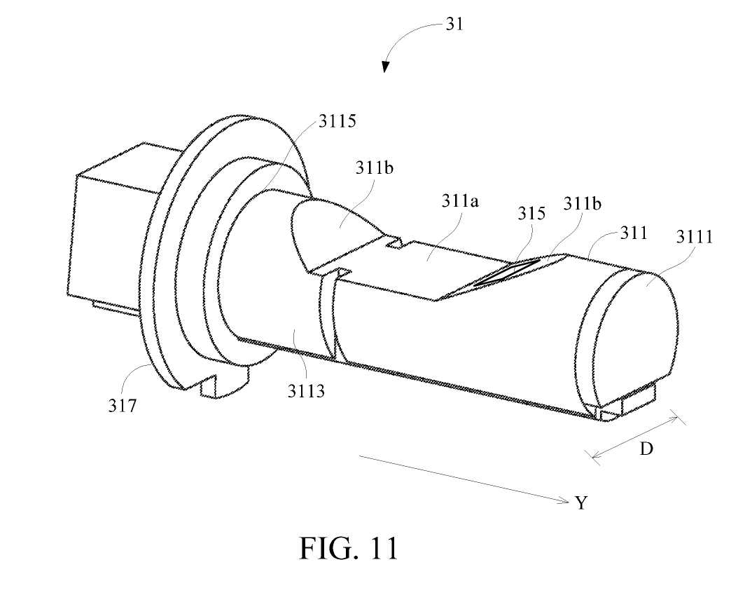

FIG. 11 depicts the light source module 31 for the vehicle illumination device 10. The light source module 31 is approximately the same as the light source module 11 of the vehicle illumination device 1. In addition to the LED light source 315 and the fixing part 317, the light source module 31 has a column 311. The column 311 has a front end 3111, a side 3113, and a back end 3115 opposite to the front end 3111. The side 3113 has a groove having a bottom 311a and two sidewalls 311b. The fixing part 317 is disposed near the back end 3115 of the column 311. In one embodiment, the column 311 is a cylinder having a side 3113. However, in other embodiments, the column 311 can be a column, such as, a cuboid, having a plurality of sides. It should be noted that the column 311 is not limited to be a cylinder having a side 3113 in the embodiment.

In one embodiment, the column 311 has a diameter D substantially from 6 mm to 18 mm. The light source module 31 is fixed in the housing 15 by the fixing part 317 through the opening 155 having the diameter substantially greater than 18 mm for complying with the architectures of original vehicle headlights having the halogen lamps or the HID lamps. Accordingly, the halogen lamps (e.g. H4, H7, H13, 9005, 9006, 9007) or the HID lamps (e.g. D1S, D2S, D4S) can be replaced by the light source module 31. Furthermore, there is a great amount of heat which decreases light efficiency of the light source module 31 when the LED light source 315 emits the light beam. In one embodiment, the column 311 is made of heat conductive material for increasing cooling efficiency of the light source module 31. For example, the column 311 can be made of aluminum, copper, lead, tin, magnesium, zinc, steel, titanium, polymer, ceramic, or a combination of the aforesaid materials. In other embodiments, the column 311 can have at least one heat pipe (not shown), a plurality of fins (not shown), or heat conductive coating (not shown) for increasing the cooling efficiency of the light source module 31. The heat conductive coating is made of tin oxide, aluminum oxide, silicon carbide, boron oxide, graphene, or carbon nanotubes.

As shown in FIG. 10 and FIG. 11, the column 311 faces the shutter 151 along a direction Y. There is a distance S substantially from 1 mm to 8 mm between the front end 3111 of the column 311 and the shutter 151. The LED light source 315 is fixed to one of the sidewalls 311b of the groove. In other words, the LED light source 315 is fixed to the side 3113 of the column 311. The direction Y forms an angle substantially less than 45 degrees with the sidewall 311b of the groove. In one embodiment, the direction Y and an optical axis of the convex lens 13 are arranged in a straight line. The shutter 151 is disposed on the direction Y and a focus of the convex lens 13. However, in other embodiments, the shutter 151 can be disposed on other locations. It should be noted that the shutter 151 is not limited to be disposed on the direction Y and the focus of the convex lens 13 in the embodiment.

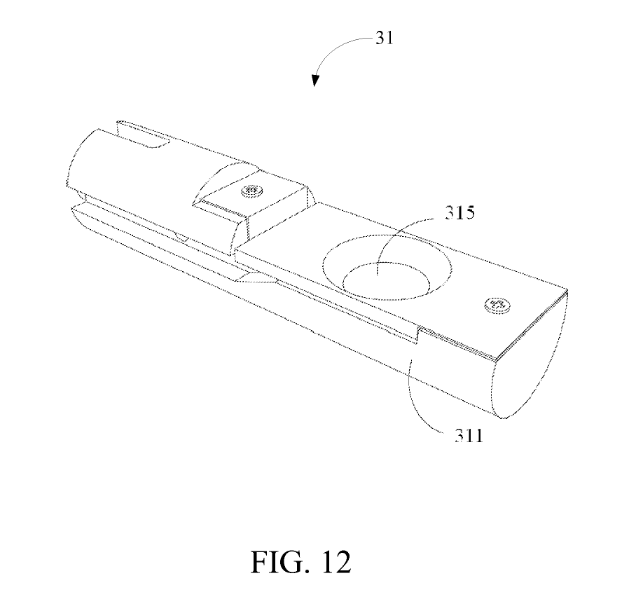

As shown in FIG. 12, another light source module 31 is disclosed. The LED light source 315 is fixed to one of the sides of the column 311 and is configured to emit a light beam for forming an illumination area having a cut-off line via the reflector and through the shutter. Similar with the aforesaid description, the LED light source 315 is a single COB chip. In one embodiment, this single COB contains, for example, twelve 4545 LED flip chips encapsulated within a circular area with a diameter which is not greater than 6 mm or between 4 mm and 6 mm More specifically, this single COB chip can generate more than 1500 lumens of 20 watts (6.5 volts and 3 amps) to provide sufficient light for regulative light distribution. That is, the light intensity (light flux per effective lighting area) of this single COB chip is no less than 100 Lm/mm². In another aspect, the single COB chip is configured to locate sufficiently nearby the focus point of the reflector 153 for better light distribution.

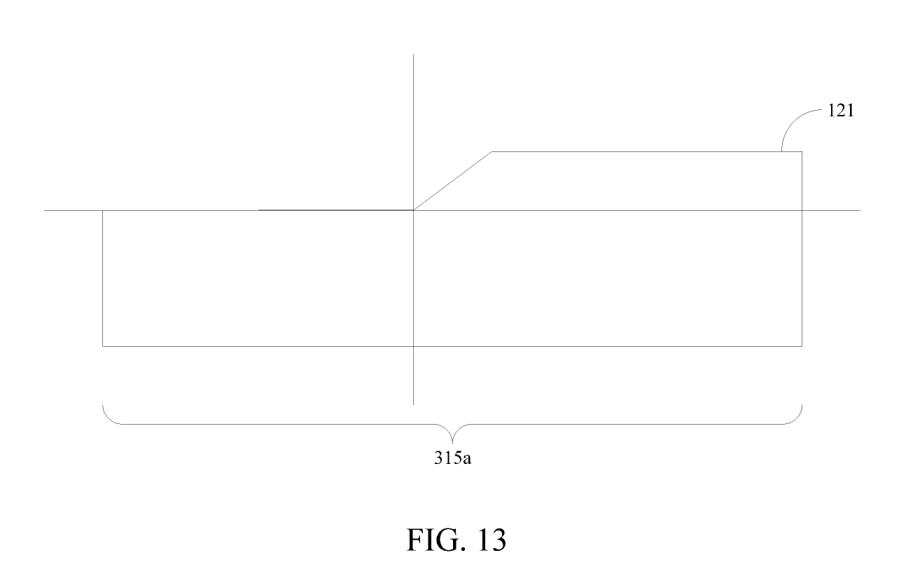

As shown in FIG. 13, an illumination area is formed on the projection plane with the distance of 25 meters ahead of the vehicle illumination device 10 by the light beam of the LED light source 315. The light beam emitted by the LED light source 315 is partly shielded by the shutter 151 to form an illumination area 315a on the projection plane with the distance of 25 meters ahead of the vehicle illumination device 10 after reflected by the reflector 153. Thus, the illumination area 315a has a cut-off line 121 for complying with asymmetrical beam illumination regulations (i.e. ECE R112).

The architectures of the LED light source 315 will be readily appreciated by those of ordinary skill in the art based on the explanation of the second LED light source 115 of the light source module 11 and, thus, will not be further described herein.

In addition to the aforesaid description, the embodiment of the vehicle illumination device 10 can also execute all the operations and functions set forth in the embodiment of the vehicle illumination device 1. How the vehicle illumination device 10 executes these operations and functions will be readily appreciated by those of ordinary skill in the art based on the explanation of the vehicle illumination device 1 and, thus, will not be further described herein.

According to the above description, the illumination device and the light source module for the illumination device according to the present invention provide a light source complying with vehicle lighting regulations and architectures of original headlights in motor vehicles. Accordingly, the illumination device and the light source module for the illumination device according to the present invention can effectively overcome the problem of the prior art that, consumers will attenuate will of replacing the halogen lamp or the HID lamp with the LED lamp.

The above embodiments merely give the detailed technical contents of the present invention and inventive features thereof, and are not to limit the covered range of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light source module for an illumination device, the illumination device comprising a reflector, the light source module comprising:
a column having a front end and a side;
a first light-emitting diode (LED) light source, fixed to the front end of the column, being configured to emit a first light beam for forming a first illumination area; and
a second LED light source, fixed to the side of the column, being configured to emit a second light beam for forming a second illumination area via the reflector;
wherein the first illumination area partly overlaps the second illumination area.

2. The light source module as claimed in claim 1, the illumination device further comprising a shutter, wherein the first light beam forms the first illumination area through the shutter, and the first illumination area has a cut-off line.

3. The light source module as claimed in claim 2, wherein a distance between the first LED light source and the shutter is substantially from 1 millimeter (mm) to 8 mm.

4. The light source module as claimed in claim 2, further comprising a concave lens fixed to the front end of the column, wherein the concave lens substantially adjoins with the shutter.

5. The light source module as claimed in claim 2, wherein luminance of the second illumination area is less than luminance of the first illumination area.

6. The light source module as claimed in claim 2, wherein an area of the first illumination area is less than an area of the second illumination area.

7. The light source module as claimed in claim 1, wherein luminance of the second illumination area is less than luminance of the first illumination area.

8. The light source module as claimed in claim 1, wherein an area of the first illumination area is less than an area of the second illumination area.

9. The light source module as claimed in claim 1, wherein the side of the column has a groove, and the second LED light source is fixed in the groove.

10. The light source module as claimed in claim 9, wherein the groove has a bottom and at least one sidewall, and the fixed on the bottom of the groove.

11. The light source module as claimed in claim 10, wherein the first light beam has an optical path forming an angle with the at least one sidewall of the groove, and the angle is substantially from 20 degrees to 50 degrees.

12. The light source module as claimed in claim 1, further comprising a fixing part, and the column further having a back end opposite to the front end, wherein the fixing part is disposed near the back end of the column.

13. A vehicle illumination device, comprising:
a housing having a shutter; and
a light source module, coupled to the housing, comprising:
a column having a front; and
an LED light source, fixed to the front end of the column, being configured to emit a light beam for forming an illumination area having a cut-off line through the shutter;
wherein the LED light source has an effective horizontal width being substantially from 6 mm to 18 mm.

14. A light source module for an illumination device, the illumination device comprising a reflector and a shutter, the light source module comprising:
a column facing the shutter along a direction and having at least one side; and
an LED light source, fixed to the at least one side of the column, being configured to emit a light beam for forming an illumination area having a cut-off line via the reflector and through the shutter;
wherein the at least one side of the column forms an angle with the direction, and the angle is substantially less than 45 degrees.

15. A light source module for an illumination device, the illumination device comprising a reflector and a shutter, the light source module comprising:
a column having at least one side; and
at least one LED light source, fixed to the at least one side of the column, being configured to emit a light beam for forming an illumination area having a cut-off line via the reflector and through the shutter;
wherein the at least one LED light source has a plurality of LED chips, each of distances between each two adjacent LED chips is substantially from 50 micrometer (μm) to 900 μm.

16. The light source module as claimed in claim 15, wherein each of the distances between each two adjacent LED chips is substantially from 50 μm to 150 μm.

17. The light source module as claimed in claim 15, wherein the at least one LED light source is a single COB chip with a diameter, and the diameter is substantially not greater than 6 mm.

18. The light source module as claimed in claim 17, wherein the single COB chip has a light intensity, and the light intensity is not less than 50 lm/mm².

19. The light source module as claimed in claim 17, wherein the single COB chip fixed to the at least one side of the column is configured to locate nearby the focus point of the reflector.
